(19) United States
(12) Patent Application Publication
(10) Pub. No.: US 2020/0007005 A1
(43) Pub. Date: Jan. 2, 2020

(54) STRAIN WAVE GEAR SPEED REDUCER, METHOD FOR MANUFACTURING STRAIN WAVE GEAR SPEED REDUCER AND ACTUATOR FOR LINK MECHANISM FOR INTERNAL COMBUSTION ENGINE

(71) Applicant: HITACHI AUTOMOTIVE SYSTEMS, LTD., Hitachinaka-shi, Ibaraki (JP)

(72) Inventors: Ken Bryan IKEGUCHI, Ayase-shi, Kanagawa (JP); Atsushi WATANABE, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/484,091

(22) PCT Filed: Feb. 2, 2018
(86) PCT No.: PCT/JP2018/003515

§ 371 Date: Aug. 6, 2019

(30) Foreign Application Priority Data
Feb. 7, 2017 (JP) 2017-020081

(51) Int. Cl. H02K 7/116; F16H 1/32; F16H 55/08

(52) U.S. Cl. CPC H02K 7/116; F16H 55/08; F16H 1/32

(57) ABSTRACT

Provided is a strain wave gear speed reducer which can improve both load torque performance and productivity, a method for manufacturing a strain wave gear speed reducer, and an actuator for link mechanism for internal combustion engine. A strain wave gear speed reducer includes; a flexible external gear having a plurality of external teeth each of which has a straight tooth profile; a rigid internal gear disposed on an outer periphery of the flexible external gear, the number of internal teeth of the rigid internal gear being greater than the number of the external teeth, the internal tooth having a straight tooth profile, and a tooth top of the internal tooth having a shape which matches or overlaps with a movement envelope of the external tooth as viewed from a direction of an axis of rotation of the flexible external gear; and a wave motion generator configured to cause the flexible external gear to be deflected in a radial direction so as to be partially engaged with the rigid internal gear, the wave motion generator being configured to rotate about an axis of rotation, thus causing an engagement portion to move in a circumferential direction.

### TECHNICAL FIELD

The present invention relates to a strain wave gear speed reducer, a method for manufacturing the strain wave gear speed reducer, and an actuator for link mechanism for internal combustion engine.

### BACKGROUND ART

An object of a strain wave gear speed reducer described in PTL 1 is to improve load torque performance by expanding an engagement area. The tooth profile of a flexible external gear and the tooth profile of a rigid internal gear are decided by the following method. First, the curved line of the tooth profile is decided with respect to one portion on the tooth top side of each external tooth of the flexible external gear. Subsequently, a wave motion generator is imaginarily rotated so as to obtain a movement trajectory of the curved line of the tooth profile relative to the rigid internal gear. The tooth profile of the rigid internal gear is decided using this envelope of the movement trajectory. Next, the wave motion generator is rotated so as to obtain the movement trajectory of internal teeth with respect to the flexible external gear. The tooth profile of the remaining portion of the external tooth of the flexible external gear is decided using this envelope of the movement trajectory.

### CITATION LIST

### Patent Literature

PTL 1: Japanese Patent Laid-Open No. 2015-075149

### SUMMARY OF INVENTION

### Technical Problem

However, the above-mentioned conventional technique has high trajectory dependency so that many restrictions are imposed on the design of a tooth profile, and the curved line of a tooth surface is complicated. Accordingly, there is a possibility of low productivity.

It is one of objects of the present invention to provide a strain wave gear speed reducer which can improve both load torque performance and productivity, a method for manufacturing the strain wave gear speed reducer, and an actuator for link mechanism for internal combustion engine.

### Solution to Problem

According to one aspect of the present invention, there is provided a strain wave gear speed reducer which includes: a flexible external gear having a plurality of external teeth each of which has a straight tooth profile; a rigid internal gear disposed on an outer periphery of the flexible external gear, the number of internal teeth of the rigid internal gear being greater than the number of the external teeth, the internal tooth having a straight tooth profile, and a tooth top of the internal tooth having a shape which matches or overlaps with a movement envelope of the external tooth as viewed from a direction of an axis of rotation of the flexible external gear; and a wave motion generator configured to cause the flexible external gear to be deflected in a radial direction so as to be partially engaged with the rigid internal gear, the wave motion generator being configured to rotate about an axis of rotation, thus causing an engagement portion to move in a circumferential direction.

Accordingly, it is possible to improve both load torque performance and productivity.

### BRIEF DESCRIPTION OF DRAWINGS

FIG. 1 is a schematic view of an internal combustion engine provided with an actuator A for link mechanism for internal combustion engine of an embodiment 1.

FIG. 2 is a cross-sectional view of the actuator A for link mechanism for internal combustion engine of the embodiment 1.

FIG. 3 is an exploded isometric view of a strain wave gear speed reducer 21 of the embodiment 1.

FIG. 4 is a schematic view showing an engaging state between a flexible external gear 36 and a rigid internal gear 27 in the embodiment 1.

FIG. 5 is a schematic view of external teeth 36a which are decided in a second decision step.

FIG. 6 is a schematic view of internal teeth 27a which are decided in a second decision step.

FIG. 7 is a schematic view showing the movement trajectory of the external tooth 36a of the flexible external gear 36 when hypocycloid motion is performed with respect to the rigid internal gear 27.

FIG. 8 is a schematic view showing the tooth profiles of the internal teeth 27a and the external teeth 36a in the embodiment 1.

### DESCRIPTION OF EMBODIMENTS

### Embodiment 1

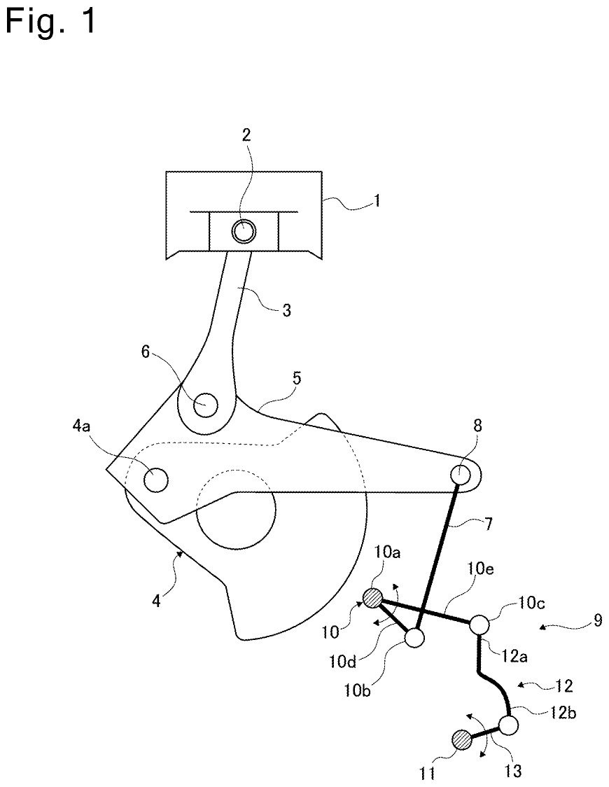

FIG. 1 is a schematic view of an internal combustion engine provided with an actuator A for link mechanism for internal combustion engine of an embodiment 1. The basic configuration of the internal combustion engine is substantially equal to the corresponding configuration of an internal combustion engine described in FIG. 1 of Japanese Patent Laid-Open No. 2011-169152. Accordingly, the basic configuration is described in a simplified manner.

A piston 1 reciprocates in the cylinder of the cylinder block of the internal combustion engine. The upper end of an upper link 3 is rotatably connected to the piston 1 via a piston pin 2. A lower link 5 is rotatably connected to the lower end of the upper link 3 via a connecting pin 6. A crankshaft 4 is rotatably connected to the lower link 5 via a crankpin 4a. The upper end portion of a first control link 7 is also rotatably connected to the lower link 5 via a connecting pin 8. The lower end portion of the first control link 7 is connected to a connection mechanism 9 which includes a plurality of link members. The connection mechanism 9 includes a first control shaft 10, a second control shaft (control shaft) 11, and a second control link 12.

The first control shaft 10 extends parallel to the crankshaft 4, which extends in a cylinder row direction in the internal combustion engine. The first control shaft 10 includes a first journal portion 10a, a control eccentric shaft portion 10b, and an eccentric shaft portion 10c. The first journal portion 10a is rotatably supported on an internal combustion engine body. The lower end portion of the first control link 7 is rotatably connected to the control eccentric shaft portion 10b. One end portion 12a of the second control link 12 is rotatably connected to the eccentric shaft portion 10c. One end of a first arm portion 10d is connected to the first journal portion 10a, and the other end of the first arm portion 10d is connected to the lower end portion of the first control link 7. The control eccentric shaft portion 10b is disposed at a position eccentric to the first journal portion 10a by a predetermined amount. One end of a second arm portion 10e is connected to the first journal portion 10a, and the other end of the second arm portion 10e is connected to the one end portion 12a of the second control link 12. The eccentric shaft portion 10c is disposed at a position eccentric to the first journal portion 10a by a predetermined amount. One end of an arm link 13 is rotatably connected to the other end portion 12b of the second control link 12. The second control shaft 11 is connected to the other end of the arm link 13 such that the second control shaft 11 cannot move with respect to the other end of the arm link 13. The second control shaft 11 is rotatably supported in a housing 20 described later via a plurality of journal portions.

The second control link 12 connects the first control shaft 10 and the second control shaft 11 with each other. The second control link 12 has a lever shape. The one end portion 12a, which is connected to the eccentric shaft portion 10c, is formed to have a substantially straight shape. On the other hand, the other end portion 12b of the second control link 12, to which the arm link 13 is connected, is formed to have a curved shape. An insertion hole is formed at the distal end portion of the one end portion 12a in a penetrating manner, and the eccentric shaft portion 10c is inserted into the insertion hole in a rotatable manner. The arm link 13 is formed as a member separate from the second control shaft 11. The rotational position of the second control shaft 11 is changed by a torque transmitted from an electric motor 22 via a strain wave gear speed reducer 21, forming a part of the actuator A for link mechanism for internal combustion engine. With the change in the rotational position of the second control shaft 11, the first control shaft 10 rotates via the second control link 12, thus changing the position of the lower end portion of the first control link 7. With such a change, the attitude of the lower link 5 varies so that the stroke position and the stroke amount of the piston 1 in the cylinder are caused to vary, thus changing the engine compression ratio accordingly.

Next, the configuration of the actuator A for link mechanism for internal combustion engine of the embodiment 1 is described.

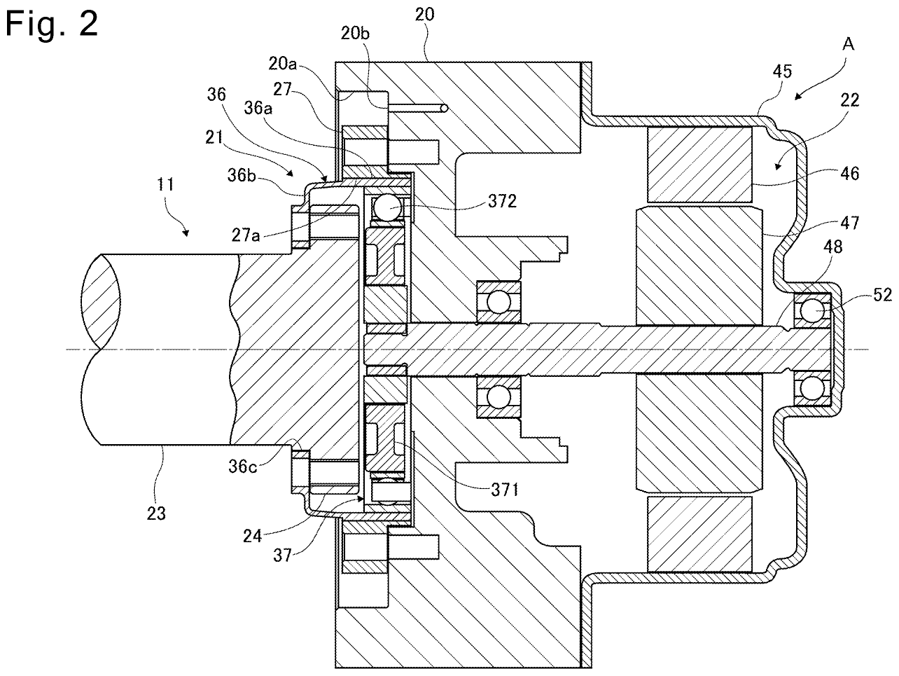

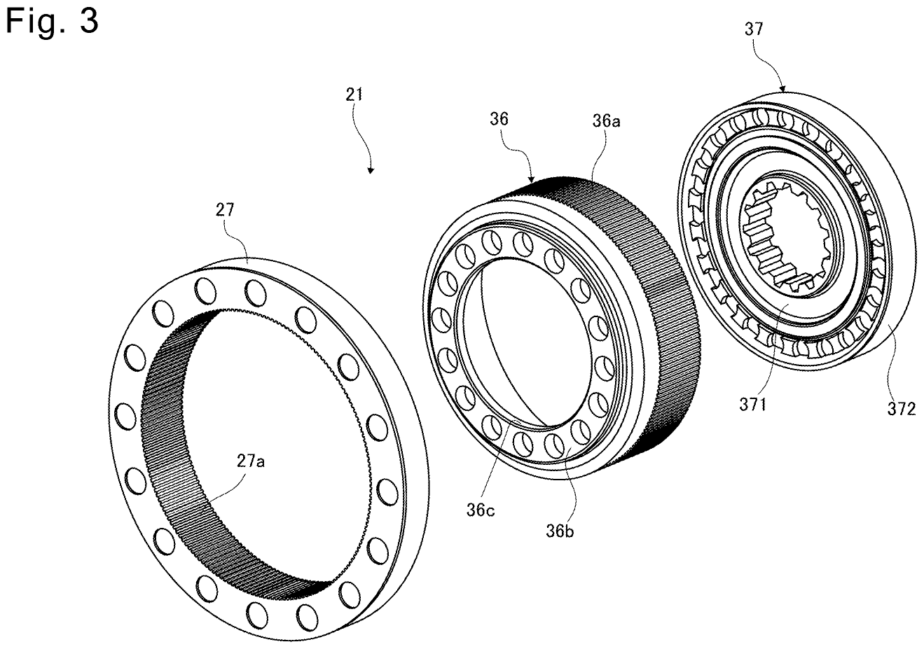

FIG. 2 is a cross-sectional view of the actuator A for link mechanism for internal combustion engine of the embodiment 1. FIG. 3 is an exploded isometric view of the strain wave gear speed reducer 21 of the embodiment 1. The actuator A for link mechanism for internal combustion engine includes the electric motor 22, the strain wave gear speed reducer 21, the housing 20, and the second control shaft 11.

The electric motor 22 may be a brushless motor, for example. The electric motor 22 includes a motor casing 45, a coil 46, a rotor 47, and a motor output shaft 48. The motor casing 45 is formed to have a bottomed cylindrical shape. The coil 46 is fixed to the inner peripheral surface of the motor casing 45. The rotor 47 is rotatably provided at a position on the inner side of the coil 46. One end portion 48a of the motor output shaft 48 is fixed to the center of the rotor 47.

The motor output shaft 48 is rotatably supported by a ball bearing 52 provided to the bottom portion of the motor casing 45. The second control shaft 11 is rotatably supported on the housing 20. The second control shaft 11 includes a shaft body 23 and a fixing flange 24. The shaft body 23 extends in an axial direction. The fixing flange 24 is positioned at one end portion of the shaft body 23, and rises outward in the radial direction. The second control shaft 11 is formed such that the shaft body 23 and the fixing flange 24 are formed into an integral body using an iron-based metal material. A plurality of bolt insertion holes are formed in the outer peripheral portion of the fixing flange 24 at equal intervals in the circumferential direction. A bolt is inserted into each bolt insertion hole so as to cause the fixing flange 24 to be coupled to a flange portion 36b of a flexible external gear 36 of the strain wave gear speed reducer 21.

Next, the configuration of the strain wave gear speed reducer 21 of the embodiment 1 is described.

The strain wave gear speed reducer 21 is mounted on the distal end side of the electric motor 22, and is housed in the housing 20. The strain wave gear speed reducer 21 is housed in an opening groove portion 20a of the housing 20. In the opening groove portion 20a, a supply hole 20b is formed at a position above the strain wave gear speed reducer 21 in the direction of gravity. Lubricating oil from a hydraulic source or the like not shown in the drawing is supplied through the supply hole 20b. When lubricating oil is supplied through the supply hole 20b, the lubricating oil is dropped to the strain wave gear speed reducer 21 disposed below the supply hole 20b, thus providing lubrication between respective rotating elements. The strain wave gear speed reducer 21 is fixed to the inside of the opening groove portion 20a of the housing 20 by bolts. The strain wave gear speed reducer 21 includes a rigid internal gear 27, the flexible external gear 36, and a wave motion generator 37.

The rigid internal gear 27 is a circular annular rigid member having a plurality of internal teeth 27a on the inner periphery thereof.

The flexible external gear 36 is disposed on the inner side of the rigid internal gear 27 in the radial direction. The flexible external gear 36 has external teeth 36a on the outer peripheral surface thereof, and the external teeth 36a are engaged with the internal teeth 27a. The flexible external gear 36 is a thin cylindrical member which is made of a metal material, which includes a bottom portion, and which is flexibly deformable. The number of the external teeth 36a of the flexible external gear 36 is less than the number of the internal teeth 27a of the rigid internal gear 27 by two. The flange portion 36b is formed on the bottom portion of the flexible external gear 36, and the inner periphery of the flange portion 36b forms an insertion hole 36c through which the second control shaft 11 is made to penetrate. The second control shaft 11 is inserted into the insertion hole 36c from the thin cylindrical member side of the flexible external gear 36, and the fixing flange 24 of the second control shaft 11 and the flange portion 36b are coupled with each other by bolts. Accordingly, the inner periphery of the insertion hole 36c can be supported on the second control shaft 11 and hence, it is possible to ensure rigidity of the bottom portion of the flexible external gear 36.

The wave motion generator 37 is formed to have an elliptical shape. The outer peripheral surface of the wave motion generator 37 slides along the inner peripheral surface of the flexible external gear 36. The motor output shaft 48 is fixed to the center of a wave generator plug 371 by press-fitting. The wave motion generator 37 includes the wave generator plug 371 and a deep groove ball bearing 372. The wave generator plug 371 has an elliptical shape. The deep groove ball bearing 372 includes flexible thin inner and outer races which allow the relative rotation between the outer periphery of the wave generator plug 371 and the inner periphery of the flexible external gear 36.

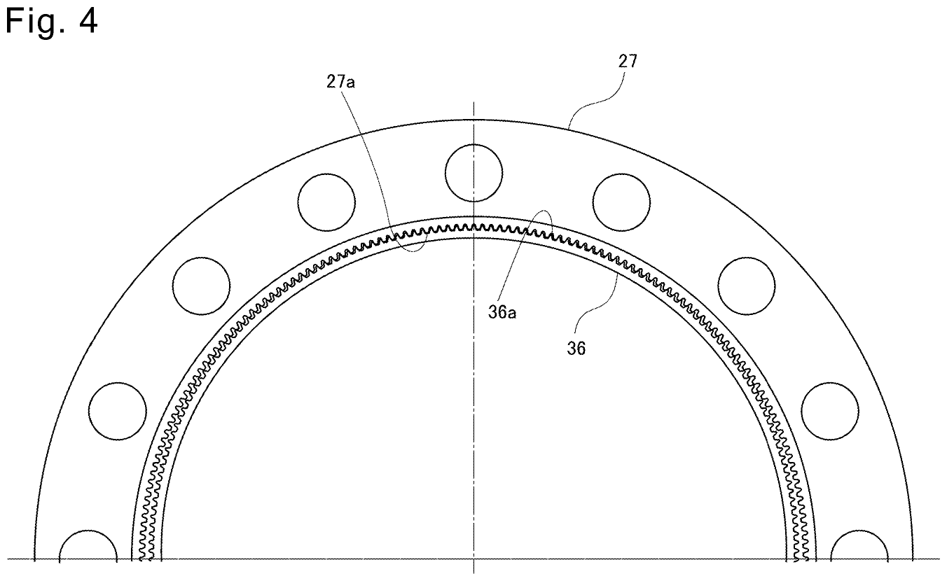

FIG. 4 is a schematic view showing an engaging state between the flexible external gear 36 and the rigid internal gear 27 in the embodiment 1. The wave generator plug 371 having an elliptical profile is fitted in the inner race of the deep groove ball bearing 372, thus causing the deep groove ball bearing 372 to follow the elliptical shape. Accordingly, the wave motion generator 37 also has an elliptical profile. Further, by fitting the wave motion generator 37 into the inner side of the flexible external gear 36 in the radial direction, the flexible external gear 36, having a circular shape in an initial state, is also deformed into an elliptical shape. The number of teeth of the flexible external gear 36, which is deflected into an elliptical shape, is less than the number of teeth of the rigid internal gear 27 by two. Accordingly, the flexible external gear 36 is engaged with the rigid internal gear 27 on the major axis of the elliptical shape with the deviation of the tooth pitch. On the other hand, on the minor axis of the elliptical shape, although the tooth pitch of the flexible external gear 36 matches the tooth pitch of the rigid internal gear 27, the flexible external gear 36 is deflected toward the axial direction and hence, the teeth do not overlap with each other, thus being prevented from interfering with each other. Accordingly, the flexible external gear 36 and the rigid internal gear 27 which differ from each other in the number of teeth by an even number can be engaged with each other as in the engaging state shown in FIG. 4.

The teeth portion of the flexible external gear 36 is flexible. However, the flange portion 36b cannot be deformed from a circular shape in order to take out output, and the flange portion 36b is directly fastened to the second control shaft 11. Accordingly, the flexible external gear 36 has a shape which expands into an elliptical shape toward the opening end portion of the thin cylindrical member using the flange portion 36b as a starting point. That is, rotational motion of the flexible external gear 36 taken out from deformation motion at a position in the vicinity of the opening end portion can be transmitted to the second control shaft 11 from the flange portion 36b.

Rotary input into the strain wave gear speed reducer 21 is converted into reciprocating displacement motion in a direction orthogonal to a rotary input shaft by the wave motion generator 37. The wave generator plug 371, which includes a rotation transmission mechanism, is driven by an input shaft which is connected to the wave generator plug 371. The inner race of the deep groove ball bearing 372, into which the wave generator plug 371 is fitted, also follows the input shaft. The shape of the inner race is transferred to the outer race of the deep groove ball bearing 372 by balls sandwiched between the inner race and the outer race. The balls have six degrees of freedom in translation and rotation so that the inner race and the outer race respectively have independent degrees of freedom in the circumferential direction. The wave generator plug 371 which is driven by the rotary input is an elliptical body so that the radius of the wave generator plug 371 varies depending on a position on the circumference of the elliptical shape. Due to such a characteristic of this elliptical shape, an increase or decrease in radius of the wave generator plug 371 which is caused by the rotation of the wave generator plug 371 is transmitted to the outer race of the wave generator plug 371 through the balls. The inner race and the outer race have a flexible thin structure. Accordingly, at this point of operation, deformation motion is performed where the outer race is synchronized with the increase or decrease in radius of the wave generator plug 371 with the restricted degree of freedom of the outer race of the deep groove ball bearing 372 in the circumferential direction.

Further, the outer race of the deep groove ball bearing 372 and the flexible external gear 36 are fitted with each other and hence, the flexible external gear 36 also performs deformation motion following the deformation motion of the outer race. This deformation motion varies an engaging position on the major axis between the rigid internal gear 27 and the flexible external gear 36. With such variation, when the teeth portions are observed in an enlarged manner from a fixed point on the rigid internal gear 27, the teeth perform relative motion in a direction orthogonal to the axis. When the position of the flexible external gear 36 in the circumferential direction varies with respect to the rigid internal gear 27 due to a difference, motion in the circumferential direction is made to overlap and hence, the external tooth 36a of the flexible external gear 36 moves inward in the radial direction along the tooth surface of the internal tooth 27a.

In the embodiment 1, to improve both load torque performance and productivity, each of the external teeth 36a of the flexible external gear 36 and each of the internal teeth 27a of the rigid internal gear 27 are caused to have a straight tooth profile where the base curve of a tooth surface has a straight line, and the tooth top of the internal tooth 27a is caused to have a shape which matches the movement envelope of the external tooth 36a as viewed from an axial direction. Hereinafter, the detailed description is made with respect to steps of deciding the tooth profile of the rigid internal gear 27 and the tooth profile of the flexible external gear 36 in a method for manufacturing the strain wave gear speed reducer 21.

(i) First Decision Step

In a first decision step, a speed reduction ratio “i”, the radius rᵢ of the reference pitch circle of the rigid internal gear 27, and the radius rₑ of the reference pitch circle of the flexible external gear 36 are decided. The speed reduction ratio “i” is set to a speed reduction ratio which the strain wave gear speed reducer 21 is required to possess. The radius rᵢ of the reference pitch circle of the rigid internal gear 27 forms the reference body of the strain wave gear speed reducer 21, and is decided based on an impact load or a fatigue load (load+rotational speed), for example. The radius rₑ of the reference pitch circle of the flexible external gear 36 is decided from the speed reduction ratio “i” and the radius rᵢ of the reference pitch circle of the rigid internal gear 27 using the relationship expressed by the following expression (1).

$$\begin{matrix}[ Formula 1 ] & \\ {r}_{i} = ( \frac{1}{i} + 1 ) \cdot {r}_{e} & ( 1 )\end{matrix}$$

(ii) Second Decision Step

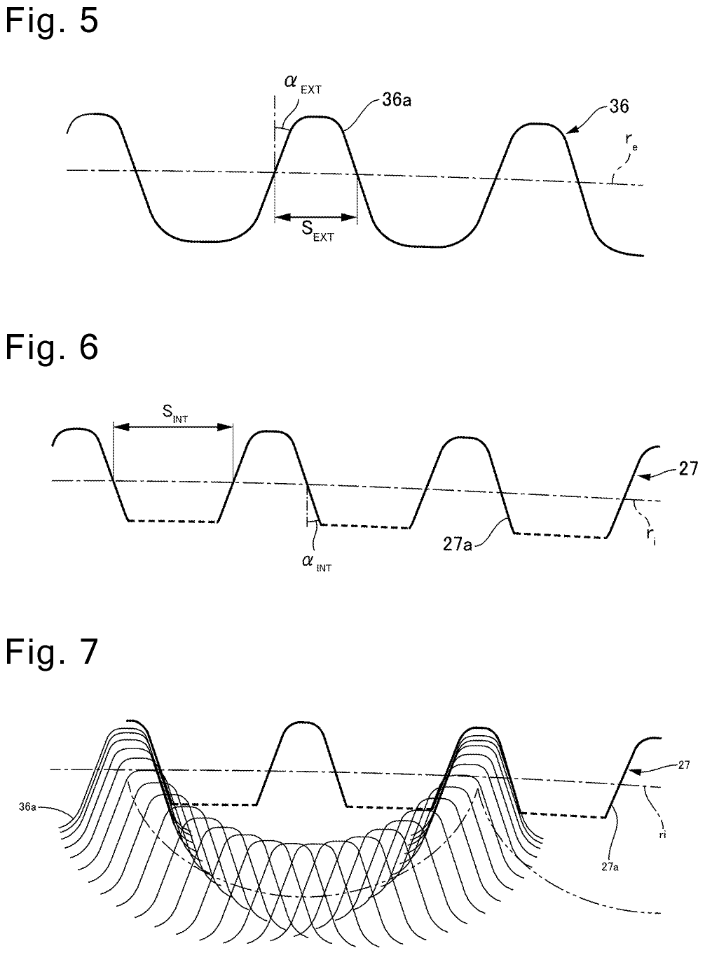

In a second decision step, the shape of the internal tooth 27a and the shape of the external tooth 36a are decided. To be more specific, from the radius rₑ of the reference pitch circle of the flexible external gear 36, which is decided in the first decision step, the tooth profile of the external tooth 36a is set to a straight tooth profile having desired dedendum, addendum, pressure angle, tooth pressure, tooth top arc, and tooth bottom arc. FIG. 5 is a schematic view of the external teeth 36a which are decided in the second decision step. FIG. 5 is a view showing the external teeth 36a in a state where the diameter of the pitch circle is set larger than the actual size, thus allowing the radius rₑ of the reference pitch circle to have a curved line close to a straight line. As shown in FIG. 5, each external tooth 36a has a straight tooth profile where the base curve of a tooth surface has a straight line.

Further, the tooth profile of the internal tooth 27a is set to a straight tooth profile where the relationships of the following expression (2) and expression (3) are satisfied, and the radius of a tooth top arc is set to 0.

$$\begin{matrix}[ Formula 2 ] & \\ {α}_{INT} = {α}_{EXT} & ( 2 ) \\ {s}_{INT} = \frac{2 {r}_{e} \cdot π - z \cdot {s}_{EXT}}{z} & ( 3 )\end{matrix}$$

In the expressions, α_{INT} indicates the pressure angle of the internal tooth 27a, α_{EXT} indicates the pressure angle of the external tooth 36a, S_{INT} indicates the tooth pressure of the internal tooth 27a, S_{EXT} indicates the tooth pressure of the external tooth 36a, and “z” indicates the number of the external teeth 36a expressed by a speed reduction ratio “i” and the relationship of z=2i. FIG. 6 is a schematic view of the internal teeth 27a which are decided in the second decision step. FIG. 6 is a view showing the internal teeth 27a in a state where the diameter of the pitch circle is set longer than the actual size, thus allowing the radius rᵢ of the reference pitch circle to have a curved line close to a straight line. As shown in FIG. 6, the internal tooth 27a has a straight tooth profile where the base curve of a tooth surface has a straight line. The shape of the tooth top of the internal tooth 27a is pending.

(iii) Third Decision Step

In a third decision step, using the tooth profile of the external tooth 36a decided in the second decision step, the movement envelope of the external tooth 36a is obtained which is generated by hypocycloid motion of the flexible external gear 36 with respect to the radius rᵢ of the reference pitch circle of the rigid internal gear 27. Then, the curved line of the tooth top of the internal tooth 27a is decided from the movement envelope of the external tooth 36a.

First, hypocycloid motion of the flexible external gear 36 is performed with respect to the radius rᵢ of the reference pitch circle of the rigid internal gear 27, thus deriving the movement trajectory of the external tooth 36a of the flexible external gear 36. Hypocycloid motion of the flexible external gear 36 is expressed by the following expression (4) using the speed reduction ratio “i”, the radius rᵢ of the reference pitch circle of the rigid internal gear 27, and the radius rₑ of the reference pitch circle of the flexible external gear 36.

$$\begin{matrix}[ Formula 3 ] & \\ [ \begin{matrix}x \\ y\end{matrix} ] = \frac{1}{i} \cdot {r}_{e} [ \begin{matrix}cos θ \\ sin θ\end{matrix} ] + {r}_{e} [ \begin{matrix}cos ( ( \frac{{r}_{i}}{{r}_{e}} - 1 ) \cdot θ ) \\ sin ( ( \frac{{r}_{i}}{{r}_{e}} - 1 ) \cdot θ )\end{matrix} ] & ( 4 )\end{matrix}$$

In the expression, “θ” corresponds to a revolution angle of a planetary carrier in the case of a planetary gear device system where the rigid internal gear 27 corresponds to a sun gear, the flexible external gear 36 corresponds to a planetary gear, and the wave motion generator 37 corresponds to a planetary carrier. That is, “θ” corresponds to an input rotation angle into the wave motion generator 37.

The external tooth 36a performs synthetic movement of translation movement and rotation movement along the movement trajectory of the external tooth 36a. The coordinate system F(s, t) of the external tooth 36a after movement is expressed by the following expression (5) using the coordinate system G(x, y) of the movement trajectory expressed by the expression (4).

$$\begin{matrix}[ Formula 4 ] & \\ [ \begin{matrix}s \\ t\end{matrix} ] = [ \begin{matrix}( {s}^{′} - x ) cos φ - ( {t}^{′} - y ) sin φ + x \\ ( {t}^{′} - y ) cos φ - ( {s}^{′} - x ) sin φ + y\end{matrix} ] & ( 5 )\end{matrix}$$

In the expression, “ϕ” indicates the rotation angle of the flexible external gear 36 which is formed along with hypocycloid motion.

FIG. 7 shows coordinates of the external tooth 36a after movement at a position of each θ expressed as described above. FIG. 7 is a view showing the external teeth 36a in a state where the diameter of the pitch circle of the internal tooth 27a is set larger than the actual size, thus allowing the radius rᵢ of the reference pitch circle to have a curved line close to a straight line. As shown in FIG. 7, it is assumed that the flexible external gear 36 has a perfect circular shape and is not deformed, and the number of the external teeth 36a is less than the number of the internal teeth 27a by two. Accordingly, the external tooth 36a is engaged with the internal tooth 27a while skipping one tooth.

Next, the shape of the tooth top of the internal tooth 27a is decided from the envelope of the obtained movement trajectory of the external tooth 36a. The coordinate system F(x, y) of the external tooth 36a is expressed by a parameter w which decides the shape of the external tooth and a parameter 4 which is formed along the movement of the external tooth 36a. That is, the coordinate system F(x, y) is expressed by the coordinate system F(s(ω, ϕ), t(ω, ϕ)) having two variables. Accordingly, the envelope of the shape of the tooth top is decided by the following expression (6).

$$\begin{matrix}[ Formula 5 ] & \\ \frac{θ s}{θ ω} \cdot \frac{θ t}{θ φ} - \frac{θ s}{θ φ} \cdot \frac{θ t}{θ ω} = 0 & ( 6 )\end{matrix}$$

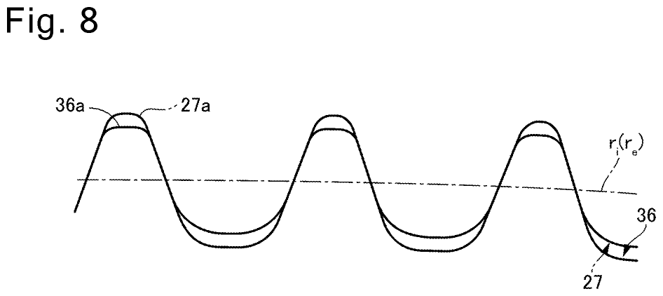

Causing the tooth top of the internal tooth 27a to have a shape decided by the expression (6) allows a manufacture of the strain wave gear speed reducer 21 where tooth top interference is avoided by adopting engagement between one tooth top and another tooth top having the shape shown in FIG. 8, and an effective contact area is expanded. FIG. 8 is a view showing the internal teeth 27a and the external teeth 36a in a state where the diameters of the pitch circles are set larger than the actual sizes, thus allowing each of the radius rᵢ of the reference pitch circle and the radius rₑ of the reference pitch circle to have a curved line close to a straight line.

The strain wave gear speed reducer is characterized in that teeth on a thin cylindrical member is caused to perform reciprocating displacement motion by the wave motion generator on an axis perpendicular cross section perpendicular to the second control shaft, and rotational motion in the circumferential direction is added which is caused by differential motion caused with circular aberration on a pitch circle on which the rigid internal gear and the flexible external gear are engaged with each other. Conventionally, in view of availability of a tool or ease of design based on the established tooth profile theory, a strain wave gear speed reducer has been used which has an involute tooth profile. However, it is not appropriate to adopt an involute tooth surface which is optimized for a general gear forming a conventional rotation transmission mechanism to a strain wave gear speed reducer having a different mechanism. For this reason, an attempt has been made to expand a simultaneous engagement area by applying, to an internal tooth and an external tooth, a shape similar to the movement trajectory of an external tooth in a state where the flexible external gear is deflected into an elliptical shape. However, such a technique has high trajectory dependency and hence, many restrictions are imposed on tooth profile design, and the curved line of a tooth surface becomes complicated, resulting in a tooth profile having low productivity.

Further, in deciding the tooth profile of a strain wave gear speed reducer, to clarify the moving state of teeth on a thin cylindrical member which is brought about by the deformation of the thin cylindrical member, the following method is mainly adopted. The state of the teeth after the thin cylindrical member is deformed into an elliptical shape is obtained by a method which uses numerical value analysis or the like, and movement of the teeth on the thin cylindrical member is checked by time history of the deformation. By adopting such a method, the tooth top having a desirably determined tooth profile is modified or displaced based on a conventional method for designing a gear so as to avoid tooth top interference (trochoid interference). However, fluctuations in analysis results are easily caused by the environment and conditions of numerical value analysis so that a tooth profile is decided in an ambiguous manner. Accordingly, it is difficult to quantitatively design a tooth profile.

In view of the above, in the embodiment 1, due to characteristics of differential motion of the strain wave gear speed reducer 21, a straight tooth profile where the base curve of a tooth surface has a straight line is adopted for both gears 27, 36 as a tooth profile which is effective in improving torque transmission capacity, and which is appropriate for expanding a contact area between the flexible external gear 36 and the rigid internal gear 27.

Further, the shape of the tooth top which can obtain contact realizing the avoidance of trochoid interference and being effective as a function of avoiding trochoid interference is decided by utilizing steps of engagement analysis. Conventionally, engagement analysis has been performed while importance is placed on realizing a continuous operation by avoiding trochoid interference. Due to the deformation of the flexible external gear 36 into an elliptical shape, a position varies on a circumference on which the flexible external gear 36 is engaged with the rigid internal gear 27. The differential principle of the flexible external gear 36 is equal to the differential principle of a planetary gear device system where the rigid internal gear 27 corresponds to a sun gear, the flexible external gear 36 corresponds to a planetary gear, and the wave motion generator 37 corresponds to a planetary carrier. Accordingly, hypocycloid motion of the flexible external gear 36 is performed on a reference pitch circle on which the flexible external gear 36 is engaged with the rigid internal gear 27, wherein the tooth profile including the shape of the tooth top is decided by the flexible external gear 36 which has a perfect circular shape and is not deformed. The shape of the tooth top of the rigid internal gear 27 is decided by the movement envelope of the external tooth 36a drawn by this motion of the flexible external gear 36.

With such a configuration, at an engaging position between the tooth surface of the external tooth 36a and the tooth surface of the internal tooth 27a in an actual use state of the strain wave gear speed reducer 21, contact engagement between one straight line tooth surface and another straight line tooth surface can be achieved in a wide range. Also at an engaging position between one tooth top and another tooth top, tooth top interference is avoided by adopting the engagement between one tooth top and another tooth top having the shape decided by the above-mentioned method. Further, the engaging position also forms an effective contact area. Accordingly, engagement can be performed in a wider range compared with the conventional method and hence, load torque performance of the strain wave gear speed reducer 21 can be improved.

Further, each of the tooth 27a and the tooth 36a has a straight tooth profile where the base curve of a tooth surface has a straight line, and the shape of the external tooth 36a can be desirably designed. The tooth top of the internal tooth 27a has a shape which follows the movement envelope of the external tooth 36a drawn when the flexible external gear 36 having a perfect circular shape and being not deformed is caused to perform hypocycloid motion. Accordingly, small restriction is imposed on the design of a tooth profile and hence, it is possible to suppress that the curved line of the tooth surface is complicated. Further, complicated numerical value analysis is unnecessary for obtaining the state of the tooth after the flexible external gear 36 is deformed into an elliptical shape. Accordingly, fluctuations in analysis results can be prevented from being easily caused by the environment and conditions of numerical value analysis and hence, it is easy to quantitatively design a tooth profile. As a result, productivity can be improved compared with the conventional strain wave gear speed reducer.

The advantageous effects of the embodiment 1 are described below.

(1) The strain wave gear speed reducer includes: the flexible external gear 36, the rigid internal gear 27, and the wave motion generator 37. The flexible external gear 36 has the plurality of external teeth 36a each having a straight tooth profile. The rigid internal gear 27 is disposed on the outer periphery of the flexible external gear 36. The number of the internal teeth 27a of the rigid internal gear 27 is greater than the number of the external teeth 36a. The internal tooth 27a has a straight tooth profile. The tooth top of the internal tooth 27a has a shape which matches the movement envelope of the external tooth 36a as viewed from the axial direction. The wave motion generator 37 causes the flexible external gear 36 to be deflected in a radial direction so as to be partially engaged with the rigid internal gear 27. The wave motion generator 37 rotates about the axis of rotation, thus causing an engagement portion to move in the circumferential direction.

By setting the tooth profile of each of the tooth 27a and the tooth 36a to a straight tooth profile, where the base curve of a tooth surface has a straight line, it is possible to suppress that the curved line of the tooth surface is complicated and hence, productivity can be improved. Further, causing the distal end of the internal tooth 27a to matches the movement envelope of the external tooth 36a allows contact engagement to be achieved in a wide range while tooth top interference is avoided and hence, load torque performance can be improved. As a result, it is possible to improve both load torque performance and productivity.

(2) The movement envelope is a trajectory of the external tooth 36a obtained as follows. Assume that the flexible external gear 36 has no deflection and is in a perfect circular state. The flexible external gear 36 in the perfect circular state is caused to perform hypocycloid motion on a reference pitch circle on which the flexible external gear 36 is engaged with the rigid internal gear 27.

With such a configuration, it is unnecessary to perform complicated numerical value analysis for obtaining the state of the tooth after the flexible external gear 36 is deformed into an elliptical shape. Accordingly, fluctuations in analysis results can be prevented from being easily caused by the environment and conditions of numerical value analysis and hence, it becomes easy to quantitatively design a tooth profile.

(3) Defining the speed reduction ratio of the strain wave gear speed reducer 21 as “i”, the radius of the reference pitch circle of the flexible external gear 36 as “rₑ”, the radius of the reference pitch circle of the rigid internal gear 27 as “rᵢ”, the rotation angle as “θ”, an axis perpendicular direction which is orthogonal to the axial center of the rigid internal gear 27 as an x axis, and a direction perpendicular to the x axis as a y axis, the tooth top of the internal tooth 27a is expressed by the expression (4) where the rotation angle θ is used as a variable.

Accordingly, the shape of the tooth top of the internal tooth 27a can be obtained from the speed reduction ratio “i” and both of the radius rᵢ of the reference pitch circle and the radius rₑ of the reference pitch circle.

(4) The pressure angle α_{INT} of the internal tooth 27a and the pressure angle α_{EXT} of the external tooth 36a are substantially equal to each other (α_{INT}=α_{EXT}).

With such a configuration, the internal tooth 27a and the external tooth 36a can be engaged with each other without causing a slide while maintaining a contact state between the tooth surface of the internal tooth 27a and the tooth surface of the external tooth 36a.

Accordingly, it is possible to realize contact engagement in a wide range between the internal tooth 27a and the external tooth 36a each having a straight tooth profile.

(5) In a method for manufacturing the strain wave gear speed reducer 21 including the rigid internal gear 27 having the plurality of internal teeth 27a each of which has a straight tooth profile, the flexible external gear 36 having the plurality of external teeth 36a each of which has a straight tooth profile, the flexible external gear 36 being disposed on the inner side of the rigid internal gear 27, and the wave motion generator 37 configured to cause the flexible external gear 36 to be deflected in the radial direction so as to be partially engaged with the rigid internal gear 27, the wave motion generator 37 being configured to rotate about the axis of rotation, thus causing an engagement portion to move in the circumferential direction, the method includes: the first decision step where the radius rₑ of the reference pitch circle of the flexible external gear 36, the radius rᵢ of the reference pitch circle of the rigid internal gear 27, and the speed reduction ratio “i” of the strain wave gear speed reducer 21 are decided; the second decision step where the shape of the external tooth 36a and the shape of the internal tooth 27a are decided based on both of the radius rₑ of the reference pitch circle and the radius rᵢ of the reference pitch circle; and the third decision step where the shape of the tooth top of the internal tooth 27a is decided by the movement envelope of the external tooth 36a.

By setting the tooth profile of each of the tooth 27a and the tooth 36a to a straight tooth profile, where the base curve of a tooth surface has a straight line, it is possible to suppress that the curved line of the tooth surface is complicated and hence, productivity can be improved. Further, causing the distal end of the internal tooth 27a to matches the movement envelope of the external tooth 36a allows contact engagement to be achieved in a wide range while tooth top interference is avoided and hence, load torque performance can be improved. As a result, it is possible to improve both load torque performance and productivity.

(6) In the actuator A for link mechanism for internal combustion engine for rotating the second control shaft 11 which changes the attitude of a link mechanism of an internal combustion engine, the actuator A includes: the electric motor 22 configured to rotationally drive the motor output shaft 48; the strain wave gear speed reducer 21 configured to reduce the rotational speed of the motor output shaft 48, and to transmit the rotational speed to the second control shaft 11; and the housing 20 configured to cover the strain wave gear speed reducer 21. The strain wave gear speed reducer 21 includes: the flexible external gear 36; the rigid internal gear 27; and the wave motion generator 37. The flexible external gear 36 has the plurality of external teeth 36a each having a straight tooth profile, and transmits a rotational force to the second control shaft 11. The rigid internal gear 27 is disposed on the outer periphery of the flexible external gear 36, and is fixed to the housing 20. The number of the internal teeth 27a of the rigid internal gear 27 is greater than the number the external teeth 36a. The internal tooth 27a has a straight tooth profile. The tooth top of the internal tooth 27a has a shape which matches the movement envelope of the external tooth 36a as viewed from an axial direction. The wave motion generator 37 is rotationally driven by the motor output shaft 48. The wave motion generator 37 causes the flexible external gear 36 to be deflected in the radial direction so as to be partially engaged with the rigid internal gear 27. The wave motion generator 37 rotates about the axis of rotation, thus causing an engagement portion to move in the circumferential direction.

By setting the tooth profile of each of the tooth 27a and the tooth 36a to a straight tooth profile where the base curve of a tooth surface has a straight line, it is possible to suppress that the curved line of the tooth surface is complicated and hence, productivity can be improved. Further, causing the distal end of the internal tooth 27a to matches the movement envelope of the external tooth 36a allows contact engagement to be achieved in a wide range while tooth top interference is avoided and hence, load torque performance can be improved. As a result, it is possible to improve both load torque performance and productivity.

### Embodiment 2

An embodiment 2 differs from the embodiment 1 with respect to a method for deciding the shape of the tooth top of the internal tooth 27a. Hereinafter, the description is made only with respect to points which are different from the embodiment 1.

In a third decision step in the embodiment 2, the shape of the tooth top of the internal tooth 27a is set to an approximate arc having the curvature of an envelope expressed by the expression (6), and the tooth top is caused to have an arc having a curvature “k” which satisfies the condition of the following expression (7).

$$\begin{matrix}[ Formula 6 ] & \\ κ ≧ \frac{1}{{( {s}^{′ 2} + {t}^{′ 2} )}^{2 / 3}} \cdot \vert {F}^{′} {F}^{″} \vert & ( 7 )\end{matrix}$$

Causing the tooth top of the internal tooth 27a to have a shape decided by the expression (7) allows, in the same manner as the embodiment 1, a manufacture of a strain wave gear speed reducer 21 where tooth top interference caused by engagement between one tooth top and another tooth top is avoided, and an effective contact area is expanded.

The embodiment 2 has the following advantageous effects.

(7) The tooth top of the internal tooth 27a follows the approximate arc having the curvature of the movement envelope.

With such a configuration, the shape of the tooth top of the internal tooth 27a can be more simplified and hence, productivity can be improved.

### Another Embodiment

The embodiments for carrying out the present invention have been described heretofore. However, the specific configuration of the present invention is not limited to the configurations of the embodiments. The present invention also includes embodiments to which design change or the like is added without departing from the gist of the invention.

Within a range where at least a portion of the above-mentioned problem can be solved or a range where at least a portion of the above-mentioned advantageous effects can be obtained, respective constitutional elements described in CLAIMS and DESCRIPTION may be desirably combined or omitted.

For example, the strain wave gear speed reducer of the present invention is not limited to an actuator for link mechanism for internal combustion engine, and is also applicable to a valve timing control device of an internal combustion engine described in Japanese Patent Laid-Open No. 2015-1190, or to a variable steering angle mechanism which can vary a turning angle with respect to a steering angle, and which is described in Japanese Patent Laid-Open No. 2011-231700 or the like.

Other modes which can be obtained from the above-described embodiments are described hereinafter.

In one of other modes, the strain wave gear speed reducer includes: the flexible external gear; the rigid internal gear; and the wave motion generator. The flexible external gear has the plurality of external teeth each of which has a straight tooth profile. The rigid internal gear is disposed on the outer periphery of the flexible external gear. The number of internal teeth of the rigid internal gear is greater than the number of the external teeth. The internal tooth has a straight tooth profile. The tooth top of the internal tooth has a shape which matches or overlaps with the movement envelope of the external tooth as viewed from the axial direction. The wave motion generator is configured to cause the flexible external gear to be deflected in the radial direction so as to be partially engaged with the rigid internal gear. The wave motion generator is configured to rotate about an axis of rotation, thus causing an engagement portion to move in the circumferential direction.

In a more preferable mode, in the above-mentioned mode, the movement envelope is the trajectory of the external tooth obtained by causing an imaginary flexible external gear having no deflection and being in a perfect circular state to perform hypocycloid motion on a reference pitch circle on which the imaginary flexible external gear is engaged with the rigid internal gear.

In another preferable mode, in any one of the above-mentioned modes, defining a speed reduction ratio of the strain wave gear speed reducer as “i”, a radius of a reference pitch circle of the flexible external gear as “rₑ”, a radius of a reference pitch circle of the rigid internal gear as “rᵢ”, a rotation angle as “θ”, an axis perpendicular direction which is orthogonal to an axial center of the rigid internal gear as an x axis, and a direction perpendicular to the x axis as a y axis, the hypocycloid motion is expressed by the following expression where the rotation angle θ is used as a variable.

$$\begin{matrix}[ Formula 7 ] & \\ [ \begin{matrix}x \\ y\end{matrix} ] = \frac{1}{i} \cdot {r}_{e} [ \begin{matrix}cos θ \\ sin θ\end{matrix} ] + {r}_{e} [ \begin{matrix}cos ( ( \frac{{r}_{i}}{{r}_{e}} - 1 ) \cdot θ ) \\ sin ( ( \frac{{r}_{i}}{{r}_{e}} - 1 ) \cdot θ )\end{matrix} ] & \end{matrix}$$

In still another preferable mode, in any one of the above-mentioned modes, the tooth top of the internal tooth follows an approximate arc having a curvature of the movement envelope.

In still another preferable mode, in any one of the above-mentioned modes, a pressure angle of the internal tooth and a pressure angle of the external tooth are substantially equal to each other.

Further, from another aspect, in one mode, in a method for manufacturing a strain wave gear speed reducer including a rigid internal gear having a plurality of internal teeth each of which has a straight tooth profile, a flexible external gear having a plurality of external teeth each of which has a straight tooth profile, the flexible external gear being disposed on an inner side of the rigid internal gear, and a wave motion generator configured to cause the flexible external gear to be deflected in a radial direction so as to be partially engaged with the rigid internal gear, the wave motion generator being configured to rotate about an axis of rotation, thus causing an engagement portion to move in a circumferential direction, the method for manufacturing a strain wave gear speed reducer includes: a first decision step where a radius rₑ of a reference pitch circle of the flexible external gear, a radius rᵢ of a reference pitch circle of the rigid internal gear, and a speed reduction ratio “i” of the strain wave gear speed reducer are decided; a second decision step where a shape of the external tooth and a shape of the internal tooth are decided based on both of the radius rₑ of the reference pitch circle and the radius rᵢ of the reference pitch circle; and a third decision step where a shape of a tooth top of the internal tooth is decided by a movement envelope of the external tooth.

In the above-mentioned mode, it is preferable that the movement envelope be a trajectory of the external tooth obtained by causing an imaginary flexible external gear having no deflection and being in a perfect circular state to perform hypocycloid motion on a reference pitch circle on which the imaginary flexible external gear is engaged with the rigid internal gear.

In another preferable mode, in any one of the above-mentioned modes, defining a rotation angle as “θ”, an axis perpendicular direction which is orthogonal to an axial center of the rigid internal gear as an x axis, and a direction perpendicular to the x axis as a y axis, the hypocycloid motion is expressed by the following expression where the rotation angle θ is used as a variable.

$$\begin{matrix}[ Formula 8 ] & \\ [ \begin{matrix}x \\ y\end{matrix} ] = \frac{1}{i} \cdot {r}_{e} [ \begin{matrix}cos θ \\ sin θ\end{matrix} ] + {r}_{e} [ \begin{matrix}cos ( ( \frac{{r}_{i}}{{r}_{e}} - 1 ) \cdot θ ) \\ sin ( ( \frac{{r}_{i}}{{r}_{e}} - 1 ) \cdot θ )\end{matrix} ] & \end{matrix}$$

Further, from another aspect, an actuator for link mechanism for internal combustion engine is an actuator for link mechanism for internal combustion engine for rotating a control shaft which changes an attitude of a link mechanism of an internal combustion engine. The actuator includes: an electric motor configured to rotationally drive a motor output shaft; a strain wave gear speed reducer configured to reduce a rotational speed of the motor output shaft, and to transmit the rotational speed to the control shaft; and a housing configured to cover the strain wave gear speed reducer. The strain wave gear speed reducer includes a flexible external gear, a rigid internal gear, and a wave motion generator. The flexible external gear has a plurality of external teeth each having a straight tooth profile, and transmits a rotational force to the control shaft. The rigid internal gear is disposed on an outer periphery of the flexible external gear, and is fixed to the housing. The number of internal teeth of the rigid internal gear is greater than the number the external teeth. The internal tooth has a straight tooth profile. The tooth top of the internal tooth has a shape which matched or overlaps with a movement envelope of the external tooth as viewed from an axial direction. The wave motion generator is rotationally driven by the motor output shaft. The wave motion generator causes the flexible external gear to be deflected in a radial direction so as to be partially engaged with the rigid internal gear. The wave motion generator rotates about an axis of rotation, thus causing an engagement portion to move in a circumferential direction.

This application claims priority based on Japanese Patent Application No. 2017-20081 filed on Feb. 7, 2017. The entire disclosure, including DESCRIPTION, CLAIMS, DRAWINGS and ABSTRACT, of Japanese Patent Application No. 2017-20081 filed on Feb. 7, 2017 is incorporated herein by reference.

### REFERENCE SIGNS LIST

A: actuator for link mechanism for internal combustion engine, 11: second control shaft (control shaft), 20: housing, 21: strain wave gear speed reducer, 22: electric motor, 27: rigid internal gear, 27a: internal tooth, 36: flexible external gear, 36a: external tooth, 37: wave motion generator, 48: motor output shaft

1. A strain wave gear speed reducer comprising:
a flexible external gear having a plurality of external teeth each of which has a straight tooth profile;
a rigid internal gear disposed on an outer periphery of the flexible external gear, the number of internal teeth of the rigid internal gear being greater than the number of the external teeth, the internal tooth having a straight tooth profile, and a tooth top of the internal tooth having a shape which matches or overlaps with a movement envelope of the external tooth as viewed from a direction of an axis of rotation of the flexible external gear; and
a wave motion generator configured to cause the flexible external gear to be deflected in a radial direction so as to be partially engaged with the rigid internal gear, the wave motion generator being configured to rotate about an axis of rotation, thus causing an engagement portion to move in a circumferential direction.

2. The strain wave gear speed reducer according to claim 1, wherein
the movement envelope is a trajectory of the external tooth obtained by causing an imaginary flexible external gear having no deflection and being in a perfect circular state to perform hypocycloid motion on a reference pitch circle on which the imaginary flexible external gear is engaged with the rigid internal gear.

3. The strain wave gear speed reducer according to claim 2, wherein
defining a speed reduction ratio of the strain wave gear speed reducer as “i”, a radius of a reference pitch circle of the flexible external gear as “rₑ”, a radius of a reference pitch circle of the rigid internal gear as “rᵢ”, a rotation angle as “θ”, an axis perpendicular direction which is orthogonal to an axial center of the rigid internal gear as an x axis, and a direction perpendicular to the x axis as a y axis,
the hypocycloid motion is expressed by a following expression where the rotation angle θ is used as a variable.
$$\begin{matrix}[ Formula 9 ] & \\ [ \begin{matrix}x \\ y\end{matrix} ] = \frac{1}{i} \cdot {r}_{e} [ \begin{matrix}cos θ \\ sin θ\end{matrix} ] + {r}_{e} [ \begin{matrix}cos ( ( \frac{{r}_{i}}{{r}_{e}} - 1 ) \cdot θ ) \\ sin ( ( \frac{{r}_{i}}{{r}_{e}} - 1 ) \cdot θ )\end{matrix} ] & \end{matrix}$$

4. The strain wave gear speed reducer according to claim 2, wherein
the tooth top of the internal tooth follows an approximate arc having a curvature of the movement envelope.

5. The strain wave gear speed reducer according to claim 2, wherein
a pressure angle of the internal tooth and a pressure angle of the external tooth are substantially equal to each other.

6. A method for manufacturing a strain wave gear speed reducer including
a rigid internal gear having a plurality of internal teeth each of which has a straight tooth profile,
a flexible external gear having a plurality of external teeth each of which has a straight tooth profile, the flexible external gear being disposed on an inner side of the rigid internal gear, and
a wave motion generator configured to cause the flexible external gear to be deflected in a radial direction so as to be partially engaged with the rigid internal gear, the wave motion generator being configured to rotate about an axis of rotation, thus causing an engagement portion to move in a circumferential direction,
the method comprising:
a first decision step where a radius rₑ of a reference pitch circle of the flexible external gear, a radius rᵢ of a reference pitch circle of the rigid internal gear, and a speed reduction ratio “i” of the strain wave gear speed reducer are decided;
a second decision step where a shape of the external tooth and a shape of the internal tooth are decided based on both of the radius rₑ of the reference pitch circle and the radius rᵢ of the reference pitch circle; and
a third decision step where a shape of a tooth top of the internal tooth is decided by a movement envelope of the external tooth.

7. The method for manufacturing a strain wave gear speed reducer according to claim 6, wherein
the movement envelope is a trajectory of the external tooth obtained by causing an imaginary flexible external gear having no deflection and being in a perfect circular state to perform hypocycloid motion on a reference pitch circle on which the imaginary flexible external gear is engaged with the rigid internal gear.

8. The method for manufacturing a strain wave gear speed reducer according to claim 7, wherein
defining a rotation angle as “θ”, an axis perpendicular direction which is orthogonal to an axial center of the rigid internal gear as an x axis, and a direction perpendicular to the x axis as a y axis,
the hypocycloid motion is expressed by a following expression where the rotation angle θ is used as a variable.
$$\begin{matrix}[ Formula 10 ] & \\ [ \begin{matrix}x \\ y\end{matrix} ] = \frac{1}{i} \cdot {r}_{e} [ \begin{matrix}cos θ \\ sin θ\end{matrix} ] + {r}_{e} [ \begin{matrix}cos ( ( \frac{{r}_{i}}{{r}_{e}} - 1 ) \cdot θ ) \\ sin ( ( \frac{{r}_{i}}{{r}_{e}} - 1 ) \cdot θ )\end{matrix} ] & \end{matrix}$$

9. An actuator for link mechanism for internal combustion engine for rotating a control shaft which changes an attitude of a link mechanism of an internal combustion engine, the actuator comprising:
an electric motor configured to rotationally drive a motor output shaft;
a strain wave gear speed reducer configured to reduce a rotational speed of the motor output shaft, and to transmit the rotational speed to the control shaft; and
a housing configured to cover the strain wave gear speed reducer, wherein
the strain wave gear speed reducer includes
a flexible external gear having a plurality of external teeth each of which has a straight tooth profile, and transmitting a rotational force to the control shaft,
a rigid internal gear disposed on an outer periphery of the flexible external gear, and fixed to the housing, the number of internal teeth of the rigid internal gear being greater than the number the external teeth, the internal tooth having a straight tooth profile, and a tooth top of the internal tooth having a shape which matches or overlaps with a movement envelope of the external tooth as viewed from a direction of an axis of rotation of the flexible external gear, and
a wave motion generator rotationally driven by the motor output shaft, the wave motion generator causing the flexible external gear to be deflected in a radial direction so as to be partially engaged with the rigid internal gear, and rotating about an axis of rotation, thus causing an engagement portion to move in a circumferential direction.
